(19) United States
(12) Patent Application Publication
(10) Pub. No.: US 2011/0009113 A1
(43) Pub. Date: Jan. 13, 2011

(54) ACCESS CONTROL USING TEMPORARY IDENTITIES IN A MOBILE COMMUNICATION SYSTEM INCLUDING FEMTO BASE STATIONS

(75) Inventors: Jari Vikberg, Jarna (SE); Tomas Nylander, Varmdo (SE); Arne Norefors, Stockholm (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (PUBL), Stockholm (SE)

(21) Appl. No.: 12/921,626

(22) PCT Filed: Mar. 10, 2009
(86) PCT No.: PCT/SE2009/050248

§ 371 Date: Sep. 9, 2010

Related U.S. Application Data
(60) Provisional application No. 61/060,277, filed on Jun. 10, 2008.

(51) Int. Cl. H04W 40/00

(52) U.S. Cl. 455/422.1

(57) ABSTRACT

The embodiments of the present invention relate to an apparatus and a method of controlling access of a UE (30, 40) in a wireless telecommunications system comprising a RAN that is adapted to communicate with the core network (34, 44). According to the method, a temporary identity of the UE (30, 40) attempting to accessing a femto RBS (31, 41) is acquired and it is further determined if the temporary identity of the UE (30, 40) is associated with a permanent identity of the UE and at least the identity of the femto RBS. In case the temporary identity is associated with the permanent identity of the UE (30, 40) and with the identity of the femto RBS, the UE (30, 40) is authorized access, otherwise it is denied access.

### TECHNICAL FIELD

The present invention relates generally to the field of mobile or wireless communications network systems, and, more specifically, to a method and an apparatus for access control in a wireless communications system comprising femto radio base stations.

### BACKGROUND

Wireless access networks have become a key element of a variety of telecommunications network environments. As to enterprise network environments, they provide convenient wireless access to network resources for employees or customers carrying laptops and/or mobile handheld devices. In addition, wireless access points operable with diverse communication devices, such as laptops, mobile phones, etc., are broadly used in public environment such as e.g., hotels, train stations, airports, restaurants, schools, universities and homes, and are mostly used to offer high-speed internet access.

The telecommunication industries and operators are currently investigating the possibility to further increase the coverage area offered by cellular communications network systems to home or small areas. Examples of cellular communication network system are: the Universal Mobile Telecommunication Systems (UMTS) network, also known as third generation (3G) cellular network system or wideband code division multiplexing access (WCDMA) network; the Global System for Mobile telecommunications (GSM) network; the General Packet Radio Service (GPRS) network that utilizes the infrastructure of a GSM system; Two further examples of cellular access networks are EDGE; EGPRS and LTE (long term evolution) which are further enhancements to GSM and GPRS and UMTS respectively. EDGE refers to enhanced Data rates for GSM Evolution, and EGPRS refers to Enhanced GPRS.

According to such investigation, a limited number of users (e.g. a user equipment (UE)) may be provided with e.g. WCDMA or 3G coverage using a small radio base stations (RBS) also called a “femto RBS” that would be connected to a radio network controller (RNC) of the 3G network using some kind of internet protocol (IP) based transmission. The coverage area so provided is called a “femto cell” to indicate that the coverage area is relatively small compared with an area of a macro cell of a public land mobile network (PLMN). Other terminology for a femto RBS includes a “Home RBS” and/or a “home 3G access point (H3GAP)” and/or a “home access point (HAP)” and/or a “home Node B (HNB)” and/or a home E-UTRAN Node B (HeNB). It should be mentioned that small cells known as picocells may serve small areas such as part of a building, a street corner or a airplane cabin and are usually smaller than microcells, which in turn is smaller than a macrocell. The picocells are traditionally provided as coverage or capacity extensions and do not include an access control mechanism. This means that all users that are allowed to access macrocells of a PLMN are also allowed to access microcells and picocells of the same PLMN.

One alternative for the IP based transmission is to use fixed broadband access (like xDSL, Cable, etc.) to connect the femto RBS to the RNC. Another alternative would be to use mobile broadband access e.g. some WiMaX technologies or HSDPA and enhanced uplink also known as HSPA.

FIG. 1 illustrates an example of a WCDMA network 10 built with a traditional architecture including one or several RNCs 16 (or femto RNCs) and femto RBSs 11 working as H3GAP. However the RBS's and RNC's may as well be collapsed and form a single node in a so called flat architecture. As shown in FIG. 1, the network 10 comprises a core network (CN) 17 connected to a RNC 16 that controls all radio base stations connected to it, i.e. macro RBS 13 and femto RBSs 11. It should be noted that the RNC 16 may comprises the functionalities of a femto RNC for controlling femto RBSs and the functionalities of a macro RNC for controlling a macro RBS. The macro RBS 13 serves a macro cell 18 whereas a femto RBS 11 serves a femto cell 12A (or 12B or 12C etc.). As illustrated, each femto RBS 11 serves its dedicated femto cell.

As well known in the art, a RBS is typically situated at an interior (e.g. centre) of the respective cell which the RBS serves, but for the sake of clarity, the macro RBS 13 and the femto RBSs 11 of FIG. 1 are shown instead as being associated by double headed arrows to their respective cells. At least some of the femto cells 12A, 12B, 12C are geographically overlayed or overlapped by the macro cell 18.

A user equipment (UE) 15 communicates with one or more cells or one or more RBSs over a radio interface. The UE 15 can be a mobile phone (or “cellular phone”), a laptop with mobile termination and thus can be e.g. portable, pocket, handheld, computer-included, or car-mounted mobile device which can communicate voice and/or data with a radio access network. The UE 15 may further communicate with the radio access network via a femto RBS 11 through an internet protocol (IP) based transmission network 14 which, as described earlier, can be either broadband fixed IP based transmission (e.g. xDSL) or broadband mobile IP based transmission (e.g. WiMaX or HSPA) or any other suitable IP based transmission.

In the wireless communications network system depicted in FIG. 1, the interface between each femto RBS 11 and the RNC (or femto RNC) 16 can be called the extended Iub interface “Iub+” which is usually formed by an IP connection over the IP based transmission network 14. In some implementations, the Iub+ resembles the Iub interface between the macro RBS 13 and the RNC 16 (or macro RNC), but the Iub+ interface is modified for conveying additional information such as the identity of the femto RBS 11 e.g. during the initial power-on procedure of the femto RBS 11. It should be mentioned that the Iub interface is not necessarily IP based.

Also illustrated in FIG. 1, the Iu interface is used between the RNC 16 and the CN 17. Note that in a flat architecture there would not necessarily exist any Iub(+) interface because, as described above, in such flat architecture the RBS and the RNC can form a single node. In order to limit the users of UEs 15 of e.g. femto cell 12C to the ones that are allowed, an access control feature can be implemented in the system. This way, at any UE attempt to camp on the femto cell, it is checked if the user is an allowed user. The international subscriber mobile identity (IMSI) of allowed users (or UEs) per femto RBS are stored in a database 19, known as an access control database (ACDB), to which the stand-alone or integrated RNC has access. Since femto cells are generally meant to serve a limited number or subset of end users, it is very important that the end user that has purchased the femto RBS gets access and is not denied access because the number of allowed users is already met by other unauthorized users. In other words, access control is important.

In the international patent application with publication number WO 2007/136339A access control is dealt with. In this prior art, the radio access network, denoted femto RAN performs access control towards a UE without involvement of the core network (CN) in order to reduce signalling load on the CN. The main principle is that the femto RAN pretends to be the CN and asks for the IMSI from the UE. Once the IMSI is known to the femto RAN, access control is performed with the information configured in the ACDB (or femto ACDB).

FIG. 2 is a diagram illustrating flow of messages describing the access control mechanism used in the above mentioned prior art. As shown, at step 201 a UE 20 receives (or reads) relevant femto cell system information from the femto RBS 21. The UE 20 reads said system information when it is initially camped on a macro cell when it detects a femto RBS. At step 202 the UE 20 attempts to camp on the femto cell that is served by the femto RBS 21. At step 203, the system information is passed to the Non-Access Stratum (NAS) layers (i.e., Mobility Management, MM) which detects that the Location Area Identity (LAI) of the femto cell is different than the previous LAI on which NAS registration was performed. Therefore, the NAS triggers a Location Updating procedure towards the network via e.g. the Radio Resource Control (RRC) layer in the WCDMA RAN case. The RRC layer in the UE 20 triggers RRC connection establishment 204 by sending an RRC CONNECTION REQUEST message to the femto RNC 22. Once the RRC connection is successfully established between the UE 20 and the femto RNC 22, the UE 20 sends a LOCATION UPDATING REQUEST message 205 to the femto RNC 22. This message contains mobile identity and other information (e.g., Location Updating type, Classmark, and so on). Normally the Temporary Mobile Subscriber Identity (TMSI) is used as the mobile identity as shown in FIG. 2, but in some cases the IMSI (or some other permanent mobile identity) may be used as the mobile identity. The Location updating type indicates normally e.g., “Normal location updating” when the UE 20 moves between Location Areas. The femto RNC 22 knows also the ID (identity) of the femto RBS (femto-RBS-ID) used for the RRC connection establishment 204 and stores this information. Since the TMSI was used as the mobile identity in the LOCATION UPDATING REQUEST message 205, the femto RNC 22 triggers an identification procedure towards the UE 20 by sending an IDENTITY REQUEST message 206 to the UE 20. The identity type requested indicates “IMSI” or some other permanent mobile identity. The UE 20 responds to the request message by sending an IDENTITY RESPONSE message 207 to the femto RNC 22. This message contains the IMSI of the UE 20. The femto RNC 22 now holds both the IMSI of the UE 20 and the femto-RBS-ID of the femto RBS 21. The femto-RNC 22 then performs an access control procedure in order to control if the user is allowed access or not. This is performed at 208 wherein the femto RNC 22 queries the ACDB 23 (or femto ACDB) with the femto-RBS-ID and the IMSI of the UE 20 to determine whether this particular UE 20 is authorized to access this particular femto RBS 21 (i.e. the system). The ACDB 23 uses the information configured in the database and returns an indication of whether access is to be denied or allowed. Details on what messages (steps) that are used in case the access is denied (steps 209-210) or allowed (steps 211-215) are shown and briefly described in FIG. 2 and these steps are also described in greater details in the above mentioned prior art document.

Although the access control mechanism described in this prior art successfully reduces the signalling and processing load towards the core network, it still has some drawbacks. One of the drawbacks is that the access control mechanism requires that the femto RAN (i.e. femto RNC and/or femto RBS) asks for the real mobile identity of the UE i.e. the IMSI (or a permanent identity of the UE) and the UE thus reveals this information which can lead to that eavesdroppers can steal it. In addition, the IMSI information is sent unencrypted from the UE to the femto RAN. This leads to that security of the UE can be compromised.

### SUMMARY

It is thus an object of the exemplary embodiments of the present invention to address the above mentioned problems and to provide a method and an apparatus of controlling access of a UE without revealing the real identity of the UE and without necessarily increasing the signalling and processing load of the core network.

According to a first aspect of embodiments of the present invention, the above stated problem is solved by means of a method of controlling access of a UE in a wireless telecommunications system comprising a radio access network (RAN) that is adapted to communicate with a core network (CN). The method comprises the steps of: acquiring a query comprising a temporary identity of the UE, for controlling whether the UE is authorized to access to the system through a femto RBS; determining whether the temporary identity of the UE is associated with at least a permanent identity of the UE and further associated with an identity of the femto RBS; and authorizing the UE to access the system when the temporary identity of the UE is associated with said at least the permanent identity of the UE and with the identity of the femto RBS; otherwise denying access to the UE.

According to a second aspect of embodiments of the present invention, the above stated problem is solved by means of an apparatus for controlling access of UE in a wireless telecommunications system comprising a RAN that is adapted to communicate with a CN. The apparatus is adapted to: acquire a query comprising a temporary identity of the UE, for controlling whether the UE is authorized to access to the system through a femto RBS. The apparatus is further adapted to determine whether the temporary identity of the UE is associated with at least a permanent identity of the UE and further associated with an identity of the femto RBS; and is further adapted to authorize the UE to access the system when the temporary identity of the UE is associated with said at least the permanent identity of the UE and with the identity of the femto RBS; otherwise the apparatus is adapted to deny access to the UE.

An advantage with the embodiments of the present invention is to achieve increased security when a UE attempts to access a network or system or a base station.

Another advantage with the embodiments of the present invention is to keep to a minimum the signalling and processing load in the core network.

Yet another advantage with the embodiments of the present invention is that no functional changes are needed in the UEs.

Still other objects and features of the present invention will become apparent from the following detailed description in conjunction with the accompanying drawings, attention to be called to the fact, however, that the following drawings are illustrative only, and that various modifications and changes may be made in the specific embodiments illustrated as described within the scope of the appended claims. It should further be understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a block diagram illustrating an exemplary wireless communications network including femto radio base stations in which the exemplary embodiments of the present invention may be used.

FIG. 2 is a signalling diagram illustrating flow of messages describing an access control mechanism in accordance to the prior art.

FIG. 3 is a signalling diagram illustrating flow of messages describing an access control mechanism in accordance with an exemplary embodiment of the present invention.

FIG. 4 is a signalling diagram illustrating flow of messages describing an access control mechanism in accordance with another exemplary embodiment of the present invention.

FIG. 5 is a signalling diagram illustrating how an update of a new temporary identity of a UE is performed using the core network.

FIG. 6 is a signalling diagram illustrating how parts of the radio access network are updated with e.g. a new temporary of the UE.

FIG. 7 is a block diagram illustrating another exemplary wireless communications network in which the exemplary embodiments of the present invention may be used.

FIG. 8 is a diagram illustrating a flowchart of a method according to exemplary embodiments of the present invention.

### DETAILED DESCRIPTION

In the following description, for purposes of explanation and not limitation, specific details are set forth such as particular architectures, scenarios, techniques, etc. in order to provide thorough understanding of the present invention. However, it will be apparent from the person skilled in the art that the present invention and its embodiments may be practiced in other embodiments that depart from these specific details.

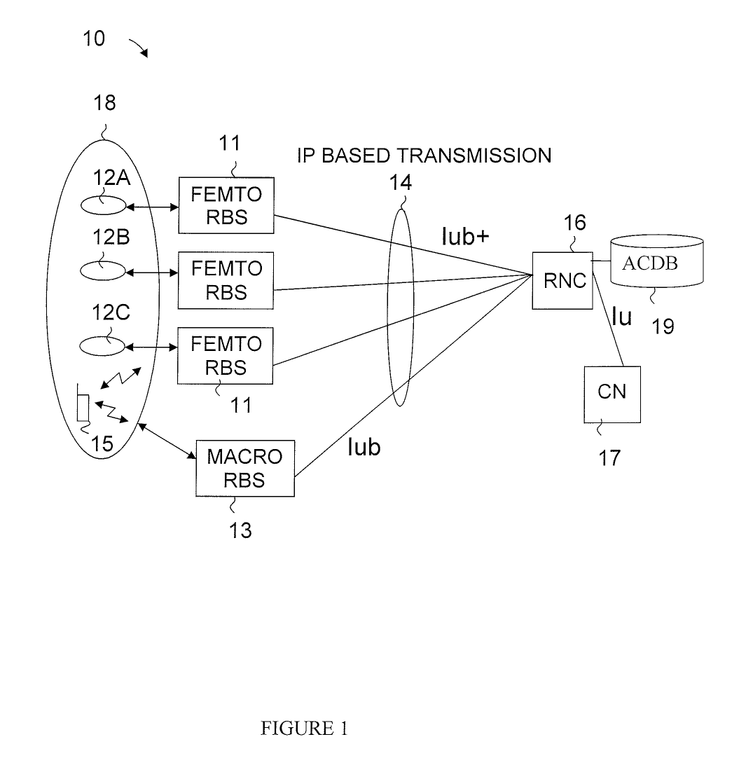

The exemplary embodiments of the present invention are described herein by way of reference to particular example scenarios. In particular the invention is described in a non-limiting general context in relation to a WCDMA wireless communications network including femto radio base stations that are connected to a radio network control node i.e. a radio network controller (RNC) of the WCDMA wireless network via a fixed IP based broadband access network in a traditional architecture as shown in FIG. 1. It should be noted that the present invention and it exemplary embodiments may also be applied to other types of radio technologies and architectures such as flat architecture for WCDMA, GSM, LTE (long term evolution), WiMAX etc.

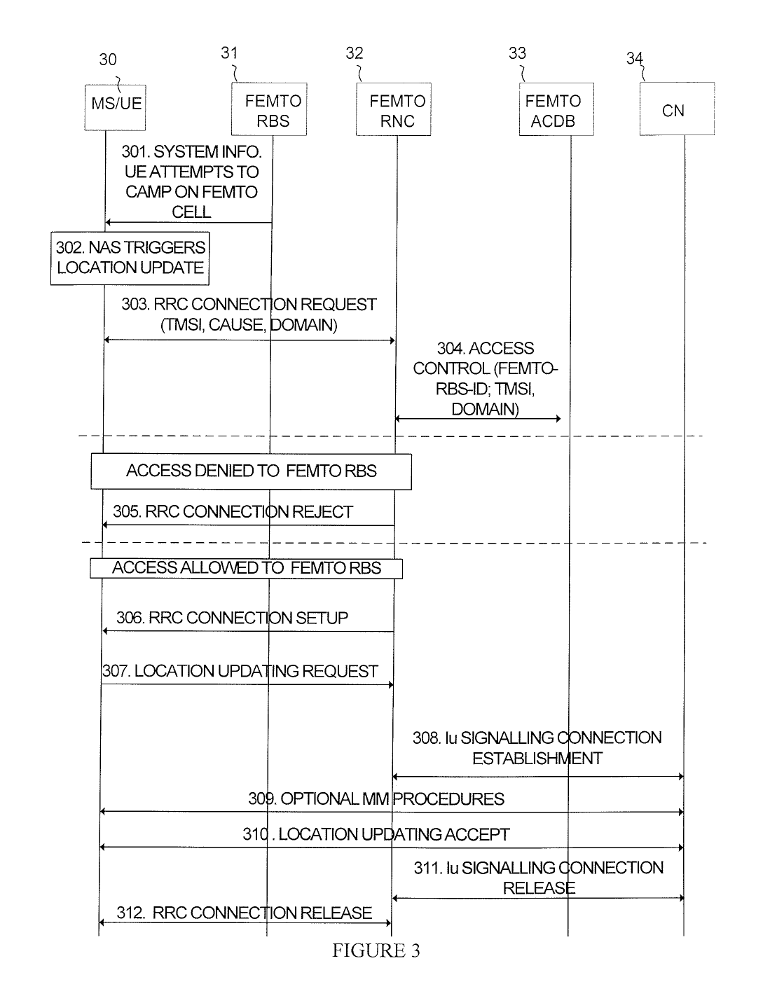

Referring to FIG. 3, a signalling diagram illustrates flow of messages describing an access control mechanism in accordance with an exemplary embodiment of the present invention. In this example, it is assumed that a circuit switched domain is used i.e. when e.g. a mobile station MS/UE 30 triggers a location update towards a CN part e.g. a mobile switching centre (MSC) (not shown). It should be noted that the same principles are also valid for a packet switched domain i.e. when the MS/UE 30 triggers a routing area update towards e.g. a serving GPRS support node (SGSN) (not shown). In addition, the described principles are not limited to only location or routing area updates i.e. the principles can be used when e.g. MS/US 30 attempts to access the network for other reasons like mobile originating call(s) and/or SMS (short message service) attempts and/or any other type of service.

As shown in FIG. 3, the exemplary apparatuses and blocks involved in the signalling diagram comprise an apparatus corresponding to a RNC, denoted femto RNC 32, which is adapted to control one or several femto RBSs 31. Also shown is a femto ACDB 33 which can be part of the femto RNC 32, thus forming a single apparatus, or the ACDB 33 may be a separate block as show in FIG. 3. However, for better understanding the principles of this first exemplary embodiment of the present invention, the femto ACDB 33 is assumed to be a separate block. The femto ACDB 33 is adapted with allowed MS/UEs for each femto RBS (e.g. femto RBS 31) using a permanent mobile identity (e.g. IMSI(s)) and a femto RBS identity (femto-RBS-ID). It is here assumed that a number of Location Area Identities (LAI) is reserved for the femto cell layer (i.e. the one served by femto RBS 31). These LAIs are defined in the CN 34 as known in the prior art. If the CN 34 knows the LAI where a specific MS/UE 30 is and if the CN 34 needs to page this MS/UE 30, then CN 34 knows which femto RNC 32 is controlling a specific Location Area and triggers a paging request towards the relevant femto RNC 32. When the femto RBS 31 is powered on, it performs predefined activities and contacts the femto RNC 32 for the initial and automatic configuration of the needed cell configuration and other information. The LAI is also allocated for each femto cell during the automatic configuration procedure. It is also assumed that the number of femto cells will be higher than the number of the reserved LAIs. This means that the same LAI will be shared by multiple femto cells and the LAI allocation mechanism can for example be some kind of random or round-robin algorithm. However the embodiments of the present invention are not restricted to any particular allocation mechanism. Furthermore, other nodes or apparatuses may also be included in FIG. 3 such as macro RBS(s) and macro RNC(s) etc.

Referring back to FIG. 3, at 301 the MS/UE 30 is assumed initially camping on a macro cell served by a macro RBS (not shown) when it detects the femto cell that is served by femto RBS 31. At this stage 301, the MS/UE 30 reads the relevant femto cell system information and attempts to camp on the femto cell. At 302, the system information is passed to the Non-Access Stratum (NAS) layers (i.e. Mobility Management (MM)) which detects that the LAI of the femto cell, which is served by femto RBS 31, is different than the previous LAI on which NAS registration was performed. NAS triggers the Location Updating procedure towards the network via the lower layers, e.g. Radio Resource Control (RRC) layer. At 303, the RRC layer in the MS/UE 30 triggers RRC connection establishment by sending a RRC CONNECTION REQUEST message to the femto RNC 32. The RRC CONNECTION REQUEST message comprises the temporary mobile identity (i.e. a TMSI) that was earlier allocated to the MS/UE 30 by the mobile network (e.g. the CN 34 or a CN part). The message also comprises an Establishment Cause (IE) with the value “Registration” (indicating Location Updating procedure). It should be noted that the RRC connection establishment may be initiated using existing principles as defined in the third generation partnership technical specification 3GPP TS 25.331.

In the RRC CONNECTION REQUEST message, the MS/UE 30 also indicates the domain (e.g. CS in this case) where the connection is to be established to. The RRC CONNECTION REQUEST can also be viewed as a query that the femto RNC 32 acquires. At 304, the femto RNC 32 is able to perform, in accordance with this exemplary embodiment of the present invention, access control since it holds enough of the needed information i.e. the temporary identity of the MS/UE 30 and the identity of the femto RBS 31 (femto-RBS-ID) that it controls.

As shown in FIG. 3 and in accordance with an exemplary embodiment of the present invention, as soon as the femto RNC 32 receives the RRC CONNECTION REQUEST message from the MS/UE 30 including the temporary identity (e.g. TMSI), it triggers access control towards the femto ACDB 33. In this case, the femto-RBS-ID, the domain, and the TMSI received in step 303 are used for the access control function. The femto ACDB 33 is adapted to return an indication if access is to be denied or allowed. As mentioned earlier, the femto ACDB 33 is configured with allowed UEs for each femto RBS using the permanent identity of the UE and a femto-RBS-ID. In other words, for each allowed MS/UE there is defined an association comprising the femto-RBS-ID which the UE is allowed to communicate with and (or access to); one or several permanent identities (e.g. IMSI) of the allowed UE; and a list of temporary identities containing e.g. different temporary identities for different domains (e.g. TMSI for circuit switched and P-TMSI for packet switched). Additional information concerning said association is described.

Referring back to FIG. 3, and as mentioned above, at step 304, it determined or checked whether the temporary identity of the MS/UE 30 is associated with at least a permanent identity of the MS/UE 30 and the femto-RBS-ID and based on this determination, an indication is returned to the femto RNC 32 on whether the MS/UE 30 is allowed access or denied access. Thus, in accordance with the exemplary embodiments of the present invention, the real identity (e.g. the IMSI) of the UE 30 is never revealed thus leading to an increased security when UE (or MS/UE) 30 attempts to get access. In addition, the signalling is also reduced between the UE 30 and the femto RNC 32 since there is no need for the femto RNC 32 to request the permanent identity of the MS/UE 30.

Note again that in the above described exemplary embodiment of the present invention, the functionality of the femto ACDB 33 may be integrated in the femto RNC 32, meaning that the access control mechanism can be locally performed within a single apparatus corresponding to the femto RNC 32 and the delay introduced by querying the femto ACDB 33 is thus eliminated.

Referring back to FIG. 3, if the MS/UE 30 is denied access, the femto RNC 32, at step 305, rejects the RRC connection establishment request by sending RRC CONNECTION REJECT message to the MS/UE 30. The femto RNC 32 is adapted to also indicate a reject cause and could include the Redirection information IE in the message which can be used to redirect the MS/UE 30 to e.g. another WCDMA macro layer frequency or to GSM or to any other type of system (e.g. LTE). One benefit with this approach is that the Redirection information IE in RRC CONNECTION REJECT message is supported by UEs already in the first revision of the 3GPP standard which is known as Release 99.

If on the other hand the MS/UE 30 is allowed access to the system (e.g. to the femto RBS 31), the femto RNC 32 is adapted to return, at step 306, a RRC CONNECTION SETUP message to the MS/UE 30 to indicated the acceptance of the establishment of the RRC connection using e.g. existing principles as defined in the technical specifications 3GPP TS 25.331.

Once the RRC connection is successfully established between the MS/UE 30 and the femto RNC 32, the MS/UE 30 sends, at step 307, a LOCATION UPDATING REQUEST message to the femto RNC 32. This message contains e.g. a mobile identity and other information (e.g. Location Updating type, Location Area Identity, Classmark etc.). The TMSI (in the case of circuit switched) is generally used as the mobile identity. The Location Area Identity indicates the registration area where the TMSI is valid. The Location updating type indicates normally “Normal location updating” when the MS/UE 30 moves between Location Areas. As mentioned earlier, the femto RNC 32 already have knowledge of the femto-RBS-ID (of femto RBS 31) which was used for the RRC connection establishment. The femto RNC 32 stores the femto-RBS-ID and the received LOCATION UPDATING REQUEST message. The femto RNC 32 may also store additional information. At 308, the femto RNC 32 triggers an establishment of the Iu signaling connection by sending a message INITIAL UE MESSAGE to the CN 36. This message contains the stored LOCATION UPDATING REQUEST message and other information. The Iu signaling connection is established using existing principles as defined in the technical specification 3GPP TS 25.413 and in e.g. other relevant 3GPP specifications.

At 309, the CN 34 may trigger optional MM procedures like identification and/or authentication towards the MS/UE 30. At step 310, it is assumed that the CN 34 accepted the Location Updating procedure and in this case the CN 34 sends a LOCATION UPDATING ACCEPT message to the MS/UE 30. At 311, the CN 34 releases the Iu signalling connection and at step 312, the femto RNC 32 releases the RRC connection by sending the RRC CONNECTION RELEASE message without including e.g. the Redirection info IE.

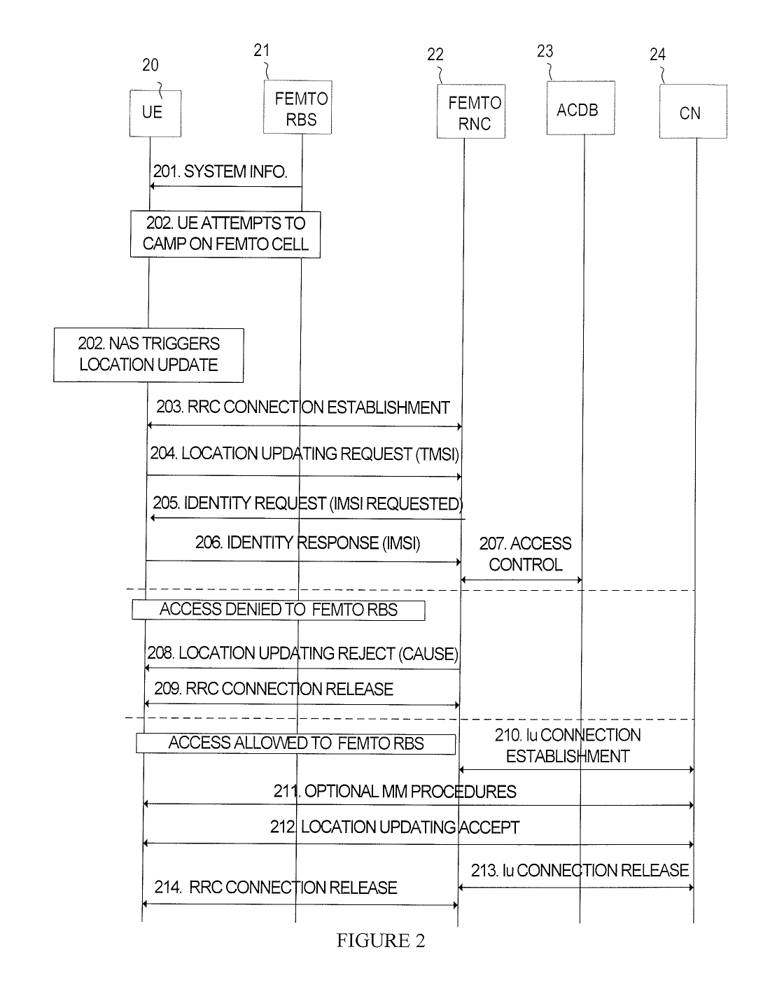

As clear from FIG. 3, the access control mechanism saves signalling compared to that of the prior art solution described in conjunction with FIG. 2. Furthermore, no functional changes are needed in the MS/UE 30.

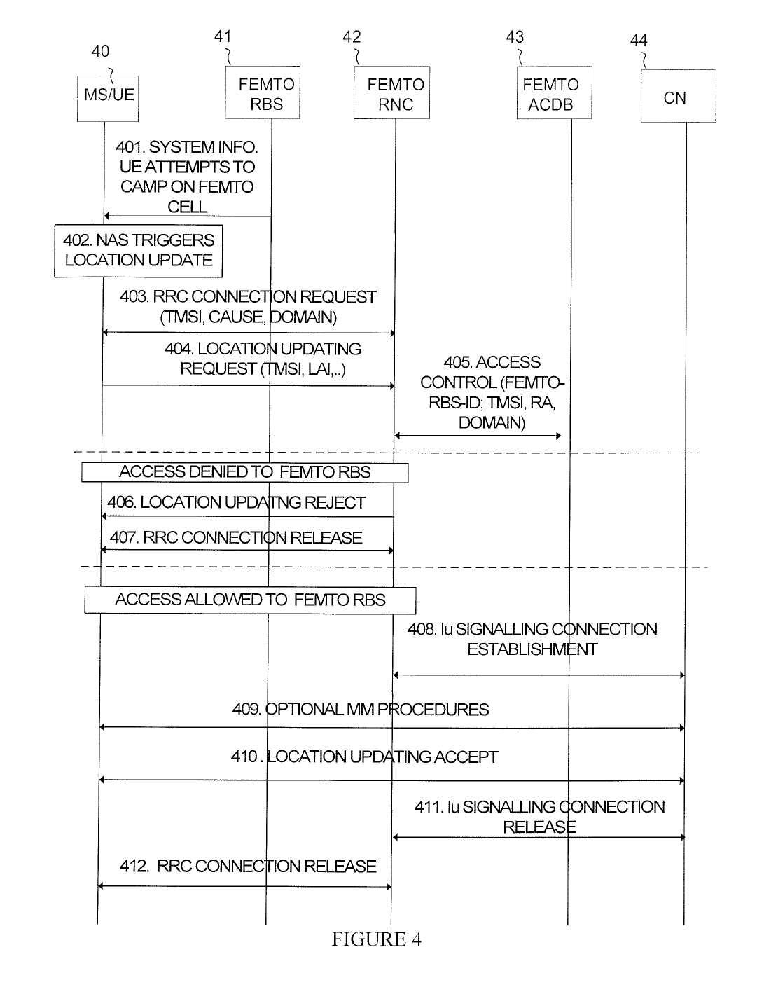

Referring to FIG. 4, a signalling diagram illustrates flow of messages describing an access control mechanism in accordance with an exemplary embodiment of the present invention. This embodiment differs from the previous one in that the node triggering the access control (e.g. the femto RNC 42) waits for the first NAS message before triggering the access control towards the femto ACDB 43. In this example, this first NAS message is the Location Updating Request message. The main reason for this would be that the NAS message may contain additional information that may be used as part of the access control. An example is the old LAI (i.e. registration area) included in the Location Updating Request message.

As shown in FIG. 4, steps 401 and 402 correspond to previously described steps 301 and 302 of FIG. 3. In step 403, the RRC layer in the MS/UE 40 triggers a RRC connection establishment by sending the RRC CONNECTION REQUEST message to the femto RNC 42. The RRC CONNECTION REQUEST message contains e.g. the temporary mobile identity that was earlier allocated to the MS/UE 40 by the mobile network (e.g. by CN 44). The message also contains the Establishment Cause IE with the value “Registration” (indicating Location Updating procedure). The RRC connection is established using existing principles as defined in 3GPP TS 25.331. The MS/UE 40 indicates also the CN domain (circuit switch in this example) where the connection is to be established to. This information is stored. Once the RRC connection is successfully established between the MS/UE 40 and the femto RNC 42, the MS/UE 40, at step 404, sends the LOCATION UPDATING REQUEST message to the femto RNC 42. This message contains mobile identity and other information (e.g. Location Updating type, Location Area Identity, Classmark etc.). The TMSI is e.g. used as the mobile identity. The Location Area Identity indicates the registration area where the TMSI is valid. The Location updating type indicates normally “Normal location updating” when the MS/UE 40 moves between Location Areas.

As in the previously described embodiment of the present invention, the femto RNC 42 knows the femto-RBS-ID used for the RRC connection establishment and stores this information. The femto RNC 42 also stores the received LOCATION UPDATING REQUEST message.

At step 405, the femto RNC 42 is able to perform the access control as it holds the needed information, i.e. the temporary identity of the MS/UE, the femto-RBS-ID of the used femto RBS 41 and additional information such as the registration area and the domain. The femto RNC 42 can then trigger access control towards the femto ACDB 43. The stored information i.e. the femto-RBS-ID; the TMSI; the domain and the registration area received can be used for the access control function. As in the previous embodiment, the femto ACDB 43 returns an indication if access is to be denied or allowed by using e.g. the previously described association approach. Again, the femto ACDB 43 and/or the functionality of the femto ACDB 43 may be an integrated part of the femto RNC 42 and therefore the delay of querying an external femto ACDB 43 can be eliminated.

At step 406 if access is to be denied, femto RNC 42 rejects the Location updating procedure by sending (MM) LOCATION UPDATING REJECT message to the MS/UE 40. The femto RNC 42 indicates also e.g. a reject cause (e.g. either “Location Area not allowed” or “No Suitable Cells In Location Area”) so that the MS/UE 40 doesn't reattempt the Location updating procedure from this LA.

The MS/UE 40 behavior for the valid reject cause codes are e.g. as defined the technical specification 3GPP TS 24.008 and which includes the following:
a. # 12 (“Location Area not allowed”): store the LAI in the list of “forbidden location areas for regional provision of service” and perform a cell selection when back to the idle state.
b. # 13 (“Roaming not allowed in this location area”) store the LAI in the list of “forbidden location areas for roaming” and perform a PLMN selection instead of a cell selection when back to the MM IDLE state.
c. # 15: (“No Suitable Cells In Location Area”) store the LAI in the list of “forbidden location areas for roaming” and search for a suitable cell in another location area in the same PLMN.

Referring back to FIG. 4, at step 407, the femto RNC 42 initiates RRC connection release procedure by sending the RRC CONNECTION RELEASE message to the MS/UE 40. the femto RNC 42 could include the Redirection info IE in the message and it is used to redirect the MS/UE 40 to another WCDMA macro layer frequency or to GSM or LTE, etc. as previously described.

If on the other hand, access of the UMS/UE 40 is allowed, the femto RNC 42 is adapted to trigger, at step 408, the establishment of the Iu signaling connection by sending the message INITIAL UE MESSAGE to the CN 44. This message contains the stored LOCATION UPDATING REQUEST message and other information. The Iu signaling connection is established using existing principles as defined in 3GPP TS 25.413 and in other relevant 3GPP technical specifications.

At step 409, the CN 44 may trigger optional MM procedures like identification and/or authentication towards the MS/UE 40. At step 410, the CN 44 is considered here to have accepted the Location Updating procedure and the CN 44 sends the LOCATION UPDATING ACCEPT message to the MS/UE 40. Subsequently at step 411, the CN 44 releases the Iu signaling connection, and after that, the femto RNC 42, at step 412 releases the RRC connection by sending the RRC CONNECTION RELEASE message without e.g. including the Redirection info IE.

As previously described, association(s) is/are used to determine whether a temporary identity of a UE (or MS/UE) is associated with at least a permanent identity of the UE and the femto-RBS-ID. Such an association can be comprised in the femto ACD or in a part of the femto RNC that can include the functionality of the femto ACDB or in a combined RNC/RBS. Note that the embodiments of the present invention are not restricted to that. An example of the contents of an association is as follows:

Association: {femto-RBS-ID, permanent UE identity, list of temporary mobile identities}

Each such association is suitable to define one allowed MS/UE for a femto RBS.

The femto-RBS-ID is considered unique and is a preconfigured identity, preferably a hardware identity of the femto RBS unit/apparatus. This identity may also be a femto-RBS-IMSI if the femto RBS is equipped with a (U)SIM for some reasons. Other types of IDs may also be used. The permanent mobile identity is e.g. the IMSI identifying the mobile (or UE) subscription that is allowed access. The list of temporary mobile identities includes a number of these temporary identities (e.g. TMSI or P-TMSI etc.). There can for example be different identities for the different domains as described before (i.e. circuit switch (CS) or packet switched (PS) etc.). In addition, these temporary identities are normally unique only on a specific registration area and this means that the registration area may also be included for every temporary mobile identity in the list. These registration areas are Location Area (LA) and Routing Area (RA) for CS and PS respectively (or Tracking Areas (TA) for LTE/SAE). This gives the following contents for the entries in the list of temporary mobile identities structure:

{Domain, Temporary Identity, Registration Area}

As an example: {CS, TMSI-x, LAI-y} or {PS, P-TMSI-x, RAI-y} where x represents for example the UE and y defines e.g. the routing area.

It should be mentioned that initially the femto ACDB (or the femto RNC part including the functionalities of the femto ACDB) is configured with the femto RBS identity and the permanent mobile identity for one association. The list of temporary mobile identities is normally configured as empty in the initial configuration. Then the CN updates the list of temporary mobile identities as a new temporary mobile identity is allocated for the MS/UE for a specific domain and registration area. This also means that no MS/UE is allowed access before a new temporary identity has been allocated for the MS/UE. This could mean a delay before the end user (or MS/UE) is allowed initial access and this delay could be minimized by adding a new HSS/HLR flag indicating that “now femto subscription has been added for this MS/UE”. The CN can then use this as an indication that a temporary identity should be reallocated for the MS/UE directly.

Note that the ACDB (or femto ACDB) may be updated with the e.g. the TMSI the MS/UE used if access was successful, so that subsequent accesses can use the TMSI.

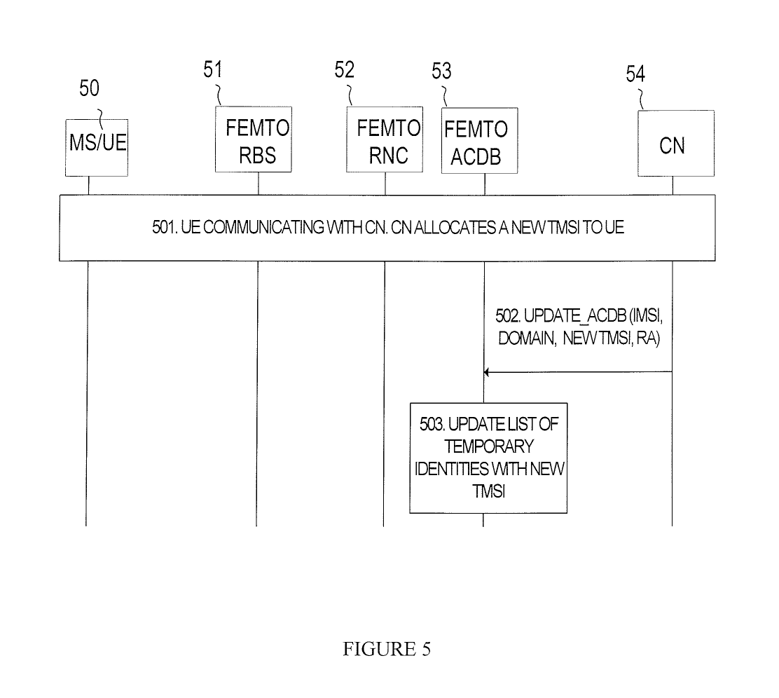

Referring to FIG. 5, a signalling diagram illustrates how an update of a new temporary identity of a UE is performed using the CN, in accordance with an exemplary embodiment of the present invention. Also here it is assumed that the CS domain is used as an example. In this case, the MSC is adapted to allocate a new TMSI for a MS/UE on a specific LA. Note that the same principles are also valid for the PS domain i.e. when the SGSN allocates a new P-TMSI for an MS/UE on a specific RA.

It should be mentioned that the exemplary embodiments of the present invention are not restricted to any particular mechanism for allocating a new TMSI or P-TMSI etc. In e.g. 3GPP TS 24.008, there are described and illustrated signalling diagrams relating to allocating temporary mobile identity for an MS/UE. In principle there exists two different methods of allocating a new TMSI for the MS/UE and these are:
1) TMSI Reallocation Procedure: In this case, the network sends a new TMSI and the associated LAI to the MS/UE using the TMSI REALLOCATION COMMAND message.
2) Location Updating Procedure: In this case, the network sends a new TMSI and the associated LAI to the MS/UE using the LOCATION UPDATING ACCEPT message.

Referring back to FIG. 5, there is shown how e.g. the femto ACDB 53 is updated using the CN 54. In step 501, the MS/UE 50 is considered communicating with the CN 54 (or Mobile CN 54) and since here it is assumed that the CS domain is used, the relevant Mobile CN node is the MSC (not shown). When the MSC (or similarly the relevant node in CN 54) decides to allocate a new temporary identity (e.g. a new TMSI) for this MS/UE 50 it communicates the new TMSI to the MS/UE 50 which also acknowledges the new TMSI. In step 502, the MSC updates the femto ACDB 53 with the new TMSI and also signals the associated domain (i.e. “CS” in this example) and the associated registration area (RA). The IMSI of the MS/UE 50 is used as the MS/UE identifier (i.e. as the unique key in the femto ACDB 53). In step 503, the list of temporary identities indicated, in femto ACDB 53, is updated so that the new TMSI is added for this MS/UE 50 (indicated by IMSI) for the indicated domain. This may mean that an old value is overwritten if it existed for the indicated domain. It should be noted that the details of the updating of the femto ACDB 53 are dependant on e.g. a table structure in the femto ACDB 53. In other words, the embodiments of the present invention are not restricted to any particular table structure. Furthermore, the details on how the updating is performed are not considered of particular relevance to the embodiments of the present invention. However, it should be noted that the update of e.g. the femto ACDB can be performed for all allowed UEs (or subscribers), or be limited to only subscribers (or UEs) being allowed to access the femto RAN (femto RBS and/or femto RNC). This information could be indicated from the HLR/HSS to the other nodes in the Mobile CN. Other possibility is that the allowed subscribers are identified by other means, e.g. different PLMN code is used for these subscribers.

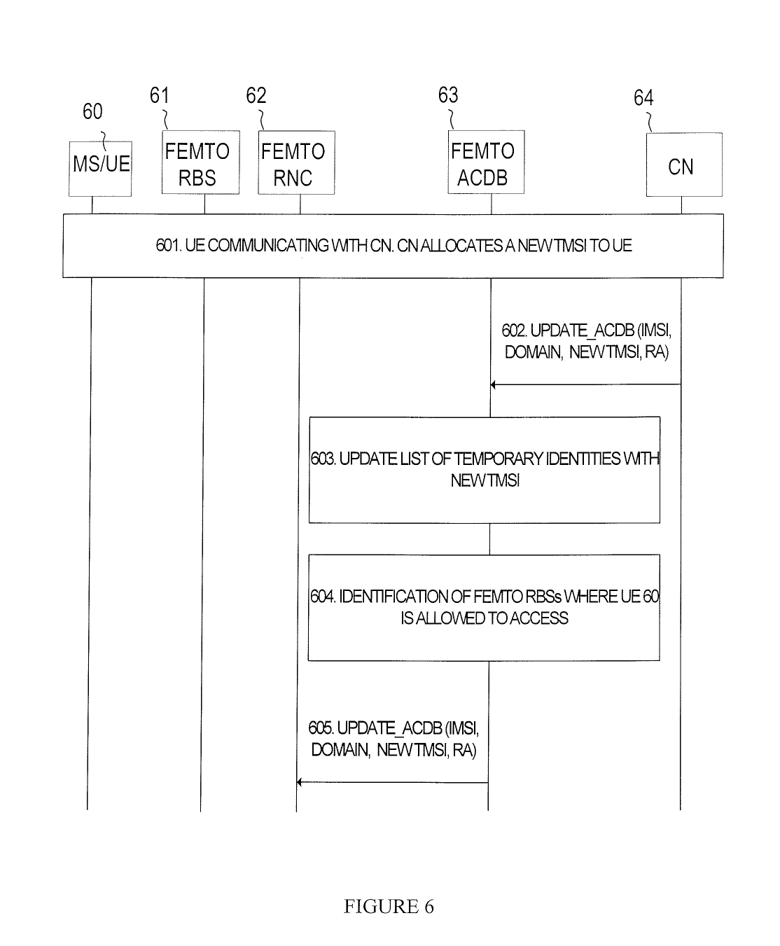

Referring to FIG. 6 is a signalling diagram illustrating how parts of the radio access network (RAN) are updated with e.g. a new temporary identity of the UE 60. In this exemplary embodiment of the present invention, the contents of the femto ACDB 63 are pushed to nodes of the RAN which include one or several apparatuses corresponding to femto RNCs 62 that control one or several femto RBSs 61 that the MS/UE 60 is allowed to access. In this exemplary embodiment, whenever the CN 64 allocates a new temporary identity for the MS/UE 60, this information (i.e. the new temporary identity) is pushed out to all femto RNCs controlling the femto RBS(s) that the UE is allowed to access. Thus, in this exemplary embodiment, the femto RNC 62 is able to perform the access control locally once any MS/UE 60 attempts to access a femto RBS and therefore additional delay to contact the femto ACDB can be removed.

As shown in FIG. 6, when the CN 64 allocates (step 601) a new temporary identity (e.g. new TMSI) for a MS/UE 60, the CN 64 is adapted (in step 602) to update the femto ACDB 63. In addition, the previously described list of temporary mobile identities is also updated (step 603) for the MS/UE 60 indicated by the IMSI that is associated with the new temporary identity (new TMSI). In step 604 an identification of the femto RBS(s) 63 where this MS/UE 60 is allowed to access, is also performed and in step 605, the contents of the femto ACDB 63 are pushed to the femto RNC 62 (or femto RNCs). Again, the contents of this information are e.g. the femto-RBS-ID; the IMSI; the type of domain used; the temporary identity (or identities) (i.e. the new TMSI); the registration area (RA), etc.

Note again that the femto ACDB 63 can be an integrated part of one or several femto RNCs 62.

According to yet another exemplary embodiment of the present invention, the contents of the ACDB can also be pushed all the way to an apparatus corresponding to a combined RNC/RBS node (or femto RNC/femto RBS). In this case the femto RNC functionality is collapsed into the femto RBS. This way the combined RNC/RBS node is introduced which is able to perform access control in accordance with previously described exemplary embodiments of the present invention. Note that if the femto ACDB is external to the combined RNC/RBS node (or RNC/RBS nodes), the information on each combined RNC/RBS node can be stored in the femto ACDB (e.g. as part of a start-up procedure) in order for the femto ACDB to be able to communicate with said combined nodes. Note also that, each node/apparatus (e.g. RNC, combined RNC/RBS, RNC+ACDB etc.) that is capable in performing the access control in accordance with the exemplary embodiments of the present invention, may further comprise a cache memory to temporary store identities for each UE that is allowed to access the femto RBS. The advantage of having a cache memory to store said identities is to save signalling and to avoid adding delay that can be introduced due to the querying of said identities from other nodes (e.g. the femto ACDB).

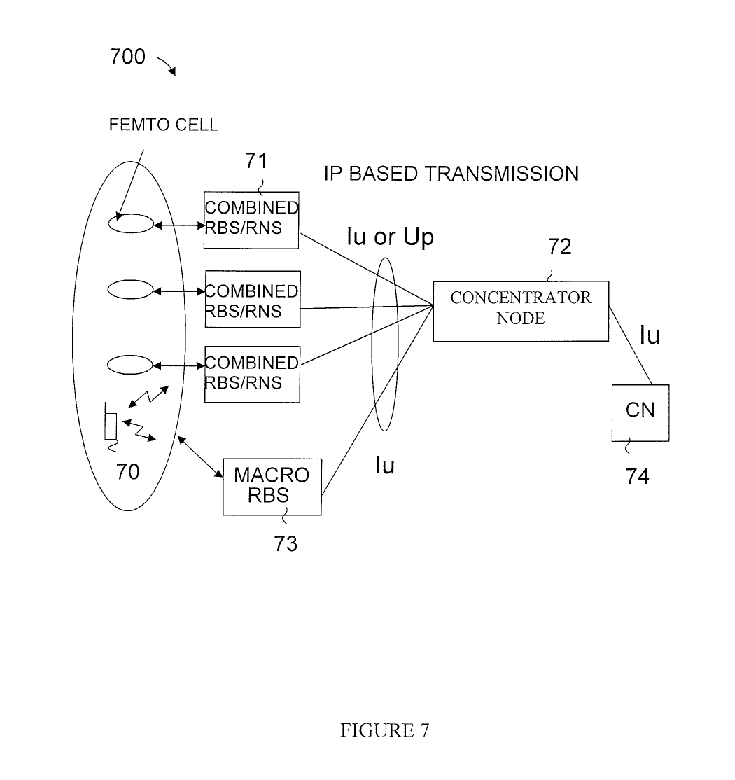

An exemplary apparatus representing a combined RBS/RNC 71 is shown in FIG. 7 which illustrates a flat architecture 700 in which the previously described exemplary embodiments of the present invention may be applied. The flat architecture 700 of FIG. 7 is suitable for use for a WCDMA network, although, the present invention is not restricted to the WCDM network.

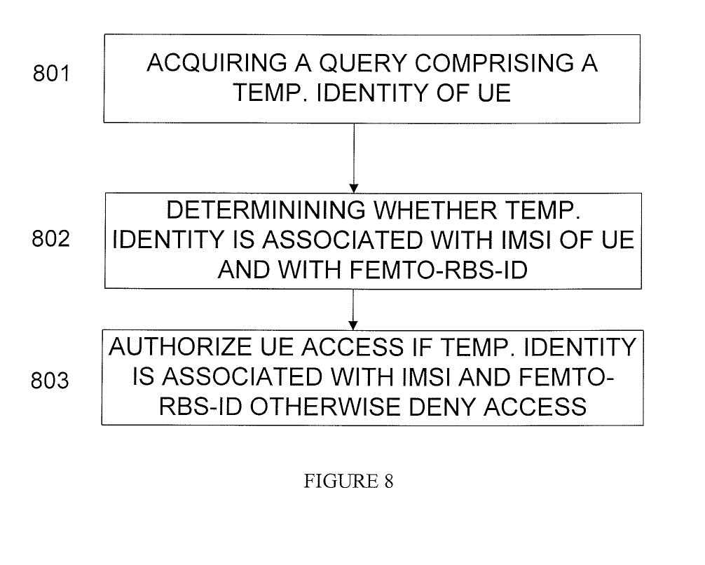

As shown in FIG. 7, the combined RBS/RNC 71 communicates with a concentrator node 72 that is capable in handling a large amount of Iu interfaces for e.g. hiding, for the CN 74 the possibly high number of combined RBS/RNCs that may be comprised in the flat architecture 700. It should be noted that a Up interface, as specified in 3GPP for GAN (Generic Access Network) may be used instead for the Iu interface between the concentrator node 72 and the combined RBS/RNCs 71. In this case the concentrator node 72 may have the functionalities of a GANC (Generic Access Network Controller). It should be mentioned that the exemplary embodiments of the present invention are also applicable in mixed architecture i.e. a mix of a traditional architecture (as the one shown in FIG. 1) and the flat architecture of FIG. 7. Furthermore, all the previously described exemplary embodiments of the present invention relating the procedure (or method) of controlling access of a UE are also applicable for the architecture of FIG. 7. The main steps of the method (or procedure) of controlling access of a UE are summarized below in conjunction with the flowchart of FIG. 8. As shown in FIG. 8, the main steps of the method comprise:

(801) acquiring a query comprising a temporary identity of the UE (e.g. TMSI or P-TMSI or any other type of temporary identity of the UE). The query is used for controlling whether the UE is authorized to access to the system through a femto RBS;

(802) determining whether the temporary identity of the UE is associated with at least a permanent identity of the UE (e.g. IMSI) and further associated with an identity of the femto RBS (e.g. femto-RBS-ID); and

(803) authorizing the UE to access the system when the temporary identity of the UE is associated with said at least the permanent identity of the UE and with the identity of the femto RBS; otherwise denying access to the UE.

As described before, the query can be acquired as soon as e.g. an apparatus corresponding to a RNC (or femto RNC or femto RNC in association with a femto ACDB; or a combined RBS/RNC; etc.) receives a RRC connection request message from the UE including the temporary identity of the UE that was previously allocated by the CN (or the relevant CN node e.g. the MSC in case of a CS domain or the SGSN in case of a PS domain etc.) to the UE. The query can also be acquired when e.g. the RNC receives a NAS message from the UE comprising the temporary identity of the UE previously allocated by the CN (or relevant CN node) to the UE. Note that no functional changes are needed in the UE(s). Additional details concerning the association list and its contents and the update of the list of temporary identities etc. have already been described and therefore they are not repeated.

The present invention and its embodiments can be realised in many ways. As an example, suitable processors in associations with software and hardware means may be used to implement the method claims. For example, one embodiment of the present invention includes a computer-readable medium having instructions stored thereon that are executable by an apparatus (e.g. a femto RNC or femto RNC in association with a femto ACDB; or a combined RBS/RNC; etc.). The instructions when executed perform the method steps as set forth in the claims.

Furthermore, the exemplary embodiments of the present invention may be implemented in any type of wireless communications system or architecture that can comprise femto nodes. By way of example, the exemplary embodiments of the present invention may be implemented in a non-limiting general context in relation to a WCDMA network and/or 3G LTE concept and/or WiMAX and/or HSPA and/or HSDPA and/or HSUPA etc.

While the invention has been described in terms of several preferred embodiments, it is contemplated that alternatives, modifications, permutations and equivalents thereof will become apparent to those skilled in the art upon reading of the specifications and study of the drawings. It is therefore intended that the following appended claims include such alternatives, modifications, permutations and equivalents as fall within the scope of the present invention.

1. A method of controlling access of a user equipment, UE, in a wireless telecommunications system comprising a radio access network, RAN, that is adapted to communicate with a core network, CN, the method comprising the steps of:
acquiring a query comprising a temporary identity of the UE, for controlling whether the UE is authorized to access to the system through a femto radio base station, femto RBS;
determining whether the temporary identity of the UE is associated with at least a permanent identity of the UE and further associated with an identity of the femto RBS; and
authorizing the UE to access the system when the temporary identity of the UE is associated with said at least the permanent identity of the UE and with the identity of the femto RBS; otherwise denying access to the UE.

2. The method according to claim 1, wherein the method comprises acquiring said query at a radio network controller, RNC, part in the RAN as soon as the RNC receives a radio resource control, RRC, connection request message from the UE comprising the temporary identity of the UE previously allocated by the CN to the UE.

3. The method according to claim 1, wherein the method comprises acquiring said query at the RNC part when the RNC receives a non access stratum, NAS, message from the UE comprising the temporary identity of the UE previously allocated by the CN to the UE.

4. The method according to claim 1 further comprising the step of maintaining, for each authorized UE, an association list comprising an identity number of femto RBS through which the UE is authorized to access the system; a permanent identity of the UE and a list of temporary identities; said list of temporary identities comprises the temporary identity of the UE previously allocated by the CN to the UE and a type of domain said authorized UE is accessing.

5. The method according to claim 4, wherein the method further comprises maintaining in said list of temporary identities, a registration area identity for every temporary identity included in the list, said registration area identity is dependent on said type of domain the authorized UE is accessing.

6. The method according to claim 4 further comprising the step of receiving from the CN an update of the list of temporary identities each time a new temporary identity is allocated by the CN to the UE.

7. The method according to claim 6 further comprises the step of identifying each femto RBS that said UE is allowed to access and sending an update of said list of temporary identities to each RNC that controls the femto RBS the UE is allowed to access.

8. The method according to claim 6 further comprises the step of identifying each femto RBS said UE is allowed to access and sending an update of said list of temporary identities to each combined RNC/RBS the UE is allowed to access.

9. The method according to claim 1, wherein the method further comprises temporary storing, in a cache memory said temporary identities for each UE that is allowed to access the femto RBS and/or the combined RNC/RBS.

10. The method according to claim 2 wherein the step of determining comprises triggering the access control towards a database that is associated with the RNC part in the RAN, in order to determine whether the temporary identity of the UE is associated with at least a permanent identity of the UE and further associated with an identity of the femto RBS.

11. An apparatus for controlling access of a user equipment, UE, in a wireless telecommunications system comprising a radio access network, RAN, that is adapted to communicate with a core network, CN, the apparatus is adapted to:
acquire a query comprising a temporary identity of the UE, for controlling whether the UE, is authorized to access to the system through a femto radio base station, femto RBS;
determine whether the temporary identity of the UE is associated with at least a permanent identity of the UE and further associated with an identity of the femto RBS; and
authorize the UE to access the system when the temporary identity of the UE is associated with said at least the permanent identity of the UE and with the identity of the femto RBS; otherwise the apparatus is adapted to deny access to the UE.

12. The apparatus according to claim 11, where the apparatus is adapted to acquire said query at a radio network controller, RNC, part in the RAN as soon as the RNC receives a radio resource control, RRC, connection request message from the UE comprising the temporary identity of the UE previously allocated by the CN to the UE.

13. The apparatus according to claim 11, where the apparatus is adapted to receive the query at the RNC part when the RNC receives a non access stratum, NAS, message from the UE comprising the temporary identity of the UE previously allocated by the CN to the UE.

14. The apparatus according to claim 11 is further adapted to maintain, for each authorized UE, an association list comprising an identity number of a femto RBS through which the UE is authorized to access the system; a permanent identity of the UE and a list of temporary identities; said list of temporary identities comprises the temporary identity of the UE previously allocated by the CN to the UE and a type of domain said authorized UE is accessing.

15. The apparatus according to claim 14, where the apparatus is adapted to maintain in said list of temporary identities, a registration area identity for every temporary identity included in the list, said registration area identity is dependent on said type of domain the authorized UE is accessing.

16. The apparatus according to claim 14 is further adapted to receive from the CN an update of the list of temporary identities each time a new temporary identity is allocated by the CN to the UE.

17. The apparatus according to claim 16 is further adapted to identify each femto RBS where the UE is allowed to access and to send an update of the list of temporary identities to each RNC that controls the femto RBS where the UE is allowed access.

18. The apparatus according to claim 16 is further adapted to identify each femto RBS where said UE is allowed to access and to send an update of said list of temporary identities to each combined RNC/RBS the UE is allowed to access.

19. The apparatus according to claim 11 is further adapted to temporary store in a cache memory the temporary identities for each UE that is allowed to access the femto RBS.

20. The apparatus according to claim 12, where the apparatus is adapted to trigger the access control towards a database that is associated with the RNC part in the RAN, in order to determine whether the temporary identity of the UE is associated with at least a permanent identity of the UE and further associated with an identity of the femto RBS.

21. The apparatus according to claim 11 corresponds to a combined node comprising the femto RBS and the RNC.

22. The apparatus according to claim 11 corresponds to the RNC in the RAN.

23. The apparatus according to claim 11 corresponds to the RNC that is in association with a database.
